(19) United States
(12) Patent Application Publication
(10) Pub. No.: US 2026/0259697 A1
(43) Pub. Date: Sep. 3, 2026

(54) SYSTEM FOR CONTROLLING AN ELECTRONIC DEVICE

(71) Applicant: Jérémy MEYSSONNIER, SAINT-AUBIN-DE-MEDOC (FR)

(72) Inventor: Jérémy MEYSSONNIER, SAINT-AUBIN-DE-MEDOC (FR)

(21) Appl. No.: 19/552,068

(22) Filed: Feb. 27, 2026

(30) Foreign Application Priority Data
Mar. 3, 2025 (FR) FR2502100

(51) Int. Cl. G06F 3/16; B60R 16/023; H04M 1/72409; H04M 1/72412; H04M 1/72466

(52) U.S. Cl. CPC G06F 3/167; B60R 16/0231; H04M 1/724098; H04M 1/72412; H04M 1/72466; H04M 2201/40

(57) ABSTRACT

A system for controlling an electronic device from a vehicle, comprising: at least one command device of the vehicle; at least one voice recognition device of the vehicle; a communication unit capable of establishing communication and exchanging data with the electronic device; a transition device configured, when the connection is established, to transform the at least one command device into at least one means for commanding the electronic device; transmitting to the electronic device by the communication unit, a first command instruction, in response to a detection of a manual command by the first detection module; transmitting to the electronic device by the communication unit, a second command instruction, in response to a detection of a voice instruction by the second detection module.

### CROSS REFERENCE TO RELATED APPLICATIONS

This application claims the benefit of priority to French patent application 2502100 filed Mar. 3, 2025, the entire disclosure of which is herein incorporated by reference.

### TECHNICAL FIELD

The invention relates to the technical field of a system for controlling an electronic device. In particular, the field of vehicle-based control systems.

### BACKGROUND

It is well known that using a cell phone while driving can be dangerous not only for the user, but also for other motorists in the vicinity. Faced with the reluctance of motorists to entirely cease using cell phones while driving, alternative solutions have been developed, such as the mirroring functions of mobile applications. However, these control systems offer only a limited possibility of continuing to use the electronic device, since only some of the applications can be accessed, and access is restricted to a few functions. With limited access to their electronic device, many users continue to use their electronic device, often on a stand, or by holding it in their hand. This practice is against the law.

The use of electronic devices while driving remains a major source of increased accidents. It is a known fact that 69% of motorists use their electronic devices while driving, and almost one accident in ten is linked to the use of a telephone while driving. The risk of accident goes up twenty-three-fold when the user is writing a message while driving. This problem also applies to any type of motor vehicle.

The invention is therefore placed in this context and seeks to resolve all the aforementioned drawbacks. Thus, the invention seeks to provide a system for complete control of the electronic device using the controls of the vehicle, without requiring any modifications to the vehicle, using the built-in controls of the vehicle and its voice recognition.

### SUMMARY

The invention relates to a system for controlling an electronic device from a vehicle, comprising: at least one command device of the vehicle, comprising a first manual command detection module; at least one voice recognition device of the vehicle, comprising a second voice command detection module; a communication unit capable of establishing communication and of exchanging data with the electronic device, a transition device configured to, following establishment of the connection between the electronic device and the vehicle, transform the at least one command device of the vehicle into at least one means of commanding the electronic device; transmit to the electronic device by the communication unit a first command instruction to command at least a first type of function of said electronic device, in response to a detection of a manual command by the first detection module; to transmit to the electronic device by the communication unit, a second command instruction to control at least a second type of function of said electronic device, in response to a voice command detected by the second detection module.

The system for controlling the electronic device can provide complete and direct control of the electronic device. The system can be used to access and interact with all the features of the electronic device.

The system for controlling the electronic device can be integrated directly into the vehicle. In another embodiment, the control system can be integrated into a box adapted to be connected to the vehicle so that when said box is connected to the vehicle, said system can operate as if it were natively installed in said vehicle.

“Vehicle” refers to any motor vehicle. In one exemplary embodiment, “vehicle” means any land vehicle such as a car, truck, bus, motorcycle, scooter, tractor, agricultural or industrial vehicle. In another example, “vehicle” means any aerial vehicle such as an aircraft.

“Electronic device” means a telephone, a laptop, a connected watch, a tablet or any other portable electronic device.

The control system may comprise a plurality of command devices of the vehicle. “Command device of the vehicle” means any manual control of the vehicle, such as, but not limited to, a knob, center console button or steering wheel control.

The voice recognition device can be that of the vehicle.

The presence of the communication unit can enable data exchange between the vehicle and the electronic device. “Data,” means media data, for example audio or video, but also control data, for example command or control instructions.

In one embodiment, the transformation of the command device of the vehicle into a means of commanding the electronic device can be achieved by the transition device, for example a dedicated button. The transition device can thus offer versatile use of existing controls. In another embodiment, the transformation can be achieved by a long press on one of the command devices of the vehicle. In a different embodiment, the transformation can be carried out by selection from a dashboard menu.

Transformation can be achieved by means of a suitable button, allowing the driver to choose which interface to control at any time.

Transforming the command devices of the vehicle into means of commanding the electronic device can enable the user to control the electronic device intuitively and securely. Each of the commands of the vehicle can then be interpreted as control commands on the electronic device. During this transformation, the voice command device of the vehicle can be adapted to control the electronic device. In this way, actions such as scrolling, clicking, or activating the voice command are translated into commands specific to the electronic device.

For example, the knob can be used to navigate through applications or elements of the phone interface, while buttons can be used to select particular elements of applications, activate specific functions, or interact with or directly within applications. The touch knob can be used for specific gestures on the electronic device, such as zooming or scrolling quickly through a list. In particular, control buttons on the steering wheel can provide quick access to the essential functions of the electronic device. In one embodiment, the command device may comprise gesture commands. In another embodiment, the command device can feature eye commands, i.e. visual recognition of eye movements could enable specific gestures such as scrolling through a list or choosing an application, akin to clicking to select.

In one embodiment, the knob can be used to move a cursor on the screen of the electronic device, giving the user maximum flexibility to interact with a variety of applications.

In another embodiment, the knob can be used to directly select interface elements, such as application icons, providing the user with a simple, low-distraction way of interacting with applications.

The first type of function may entail scrolling through applications, opening a message, scrolling quickly through a list, accessing multimedia services without leaving the vehicle commands, selecting a contact for a call, managing music lists, and changing songs. The first instruction can be associated with a function of directly controlling the electronic device.

Using the command devices of the vehicle to control the electronic device provides an interface that is intuitive and familiar to the user, which can help reduce distraction and improve road safety.

The second type of function refers to making a call or replying to a text message. The second instruction can be associated with a voice assistant function of the electronic device.

For the user, the ability to use the manual command devices, the voice recognition device, or both, gives the system greater flexibility in controlling the electronic device, adapting to user preferences and different driving situations.

In a particular embodiment of the invention, the system can be directly integrated into the branded software of the vehicle manufacturer.

The ability to transform vehicle command devices into a seamless means of commanding the electronic device can maximize safety by allowing the driver to concentrate on driving while retaining full control of the electronic device using simple, familiar controls. This transformation can also reduce distractions by eliminating the need to handle the phone.

The system is easy to implement, since it can be configured and used without the need to install any intermediate software.

In one embodiment, the system can be integrated into the vehicle when the on-board computer of the vehicle is being updated.

In another embodiment, the system can be natively integrated into the vehicle.

Thanks to the invention, the implementation of this complete control can enable all the applications and features of the electronic device to be used directly by the controls and other features of the car, minimizing physical distractions, preventing hand-held use of the phone, and keeping the user from having to look away from the road. What's more, the indirect but complete control of the electronic device by the vehicle controls can make it possible to comply with the law by limiting physical and visual distractions while keeping hands on the wheel and therefore in control of the vehicle.

Advantageously, the at least one command device comprises a button.

The use of a button can provide a familiar tactile interface for the user, reducing the learning curve.

Advantageously, the first command detection module is adapted to detect a manual press on the button.

When the user interacts with one of the command devices of the vehicle, the associated first command detection module detects said manual button press command, which is transmitted to a control unit of the command device, which communicates said instruction to the electronic device via the communication unit.

The detection of a manual press on the button offers the advantage of direct and immediate interaction, enabling precise control. This detection can be implemented in several different embodiments. In one embodiment, a pressure sensor capable of detecting different levels of pressure can be envisaged, thus enabling variable degrees of commands. In one embodiment, a press duration detection system could differentiate between short and long presses, increasing the command options using a single button. In a different embodiment, a capacitive sensor could detect simple contact without pressure, offering gentler operation.

Advantageously, the second command detection module is adapted to detect a voice instruction.

The voice recognition device of the vehicle can provide a hands-free interface, which can improve safety by allowing the driver to keep their hands on the wheel. The voice recognition device of the vehicle can feature a microphone built into the passenger compartment, directional microphones for each seat, an ambient noise reduction system, or activation based on a specific keyword.

The voice recognition device of the vehicle can provide smooth and secure interaction with the electronic device by reducing distractions while enabling important actions to be performed for the user.

Use of the voice recognition device can enable drivers to interact with their smartphone without having to use their hands, which can enhance safety and fluidity of use. For example, when a message arrives in a messaging application, a long press on the voice recognition button can be used to dictate and send a response in the form of a voice message, or to transcribe the text spoken orally into a written message.

In one embodiment, a keyword detection system for activation can enable targeted use and avoid accidental triggering.

Advantageously, the voice recognition device is adapted to transmit the detected voice instructions to a voice assistant of the electronic device.

Using the voice system of the vehicle can enable the user to give voice instructions to the electronic device, with the vehicle being able to activate the voice assistant of the electronic device.

In one embodiment, the voice recognition device may comprise a system for translating vehicle-specific commands into assistant-compatible commands.

Advantageously, the control system comprises a connection detection module adapted to detect when the electronic device has connected to the vehicle and to, as a result of said connection detection, trigger the transformation and transmission steps by activating the transition device in response to said connection detection.

The detection module adapted to detect when the electronic device is connected, causing the transition device to activate, can offer automatic configuration of the system. In one embodiment, automatic detection can be performed wirelessly. In another embodiment, automatic detection may comprise a near-field recognition system, enabling virtually instantaneous connection by simply approaching the device. In another embodiment, automatic detection may comprise a wired connection with plug-in detection.

The presence of this module can enable automatic activation of the transition device as soon as the electronic device is connected to the vehicle. Eliminating the need for the user to manually activate the system can help to ensure that the system can be used without any strain on the user by guaranteeing that the control features of the electronic device are immediately available as soon as the user enters the vehicle.

Advantageously, following the activation of the transition device, the detection of a command by the first detection module causes the first command instruction to be sent to the electronic device.

The detection of a command by the first detection module can be converted by the communication unit into a simulated direct interaction such as tapping, sliding or long pressure as usually used on the electronic device.

Advantageously, the transformation of the at least one command device of the vehicle into at least one means of commanding the electronic device is based on a source-switching system.

The transformation is based on a source-switching system, which can offer greater flexibility in the management of controls between the vehicle and the electronic device.

The use of a source-switching system can make optimal use of the existing command device interfaces of the vehicle, without the need for additional hardware dedicated to controlling the electronic device. In one embodiment, the source-switching system could be based on a software changeover that redirects input signals to different device drivers. Changing the source can provide access to the data on the electronic device. Changing the source can be used to directly control the electronic device.

When the transformation is effective and the user presses one of the command devices on the steering wheel, the transformation is ensured by a communication protocol set up between the various command devices and a central unit of the vehicle, for example an electronic interface or the engine computer. In one embodiment, communication is managed by a digital bus such as the CAN (controller area network) or LIN (local interconnect network). Thus, the detecting of the connection between the electronic device and the vehicle causes a coded message to be sent over the communication bus. The central unit of the vehicle can receive this message, interpret it, and execute the associated command, i.e. transforming the vehicle's command device into a means of commanding the electronic device. The message transmitted to the central unit contains an identifier indicating the origin of the signal, data representing the requested action and a checksum adapted to verify, with a very high probability, that the integrity of the command has been preserved.

Subsequently, when the detection module detects a command, a coded message containing the associated command is sent to the central unit. The central unit receives and processes the signal. In return, and substantially immediately, the central unit sends back to the electronic device the information concerning the command to be carried out to control said electronic device, for example by activating feedback by modifying the display on the screen of said electronic device, or an audible signal confirming the activation or deactivation of a function.

Advantageously, the voice recognition device is adapted to distinguish standard voice commands from voice commands specific to a given application of the electronic device.

The system can use the native voice command feature of the electronic device by operating a particular command device on the steering wheel. When the user presses this command device, he or she can make calls, send simple messages, launch navigation, or simply control the opening of an application. In this embodiment, control is intuitive and instantaneous, eliminating the need for the user to manipulate the touchscreen or physical controls while driving.

The system can use the voice command device of the vehicle to recognize and activate application-specific voice commands. For example, a long press on the command device activating voice recognition can enable the user to trigger a voice command mode within a specific application. In one embodiment, a user wishing to dictate a voice note or dictate a voice message into a specialized messaging application could use the voice command device of the vehicle, while keeping his or her hands on the steering wheel. In a particular embodiment, the system may be able to detect that the user is requesting the opening of an application using standard voice commands. Once the application is open, the system detects that the new voice commands issued by the user are specific to the application. In another embodiment, a brief press, i.e. one whose duration is less than a threshold value, can make it possible to detect a standard voice command, and a prolonged press, i.e. one whose duration is greater than the threshold value, can make it possible to detect a voice command specific to the open application.

This distinction can enable more precise, context-sensitive management of voice commands, improving the overall efficiency of the system. In one embodiment, a machine learning system, such as artificial intelligence, can be implemented to improve recognition over time, adapting to the unique pronunciation and habits of the user. An automatically updated database of application-specific commands can provide greater flexibility and compatibility with new features.

Advantageously, the at least one command device associated with safety functions of the vehicle is adapted to retain its native functionality.

Critical command devices related to vehicle safety and comfort, such as air conditioning and heating, indicators, lights, hazard lights, wipers and horn, can remain autonomous and independent of the electronic device control mode, even when the vehicle is converted to an electronic device control mode. These functions can remain accessible at all times, ensuring that critical vehicle functions remain active.

Maintaining the functionality of safety-related command devices can thus provide a crucial guarantee of safety by preserving critical vehicle functions. This essential feature can be implemented in a number of ways to ensure maximum reliability. A system of absolute priority for safety commands could be implemented, ensuring that these critical functions always remain accessible and operational, whatever other operations are in progress and regardless of the connection or control status of the electronic device. This feature can ensure that vehicle safety is never compromised as a result of integrating the system for controlling the electronic device.

In one embodiment, the system may comprise an automatic changeover mode in the event of an emergency being detected, enabling a rapid and appropriate response to critical conditions.

In one embodiment, the system may comprise an implementation of a whitelist of commands that can never be reassigned, thus ensuring that these security functions always remain active. In another embodiment, the system could be based on a priority system, where safety-related commands always have the highest priority, overriding any other assigned function.

Advantageously, the communication unit is adapted to communicate with the electronic device via a wireless connection.

Once the electronic device is coupled to the vehicle, commands detected by the command devices of the vehicle or voice recognition device are transmitted to said electronic device as control signals via the communication unit, so as to simulate direct interactions such as tapping, sliding or long presses.

In one embodiment, the wireless connection can be a Bluetooth® type connection. In another embodiment, the wireless connection can be a Wi-Fi connection, which can offer higher bandwidth and enable smoother interactions, particularly for tasks such as real-time navigation or media transfer, for example audio.

Advantageously, the communication unit is adapted to communicate with the electronic device via a wired connection.

When the wired connection is used, the vehicle can establish a direct connection with the electronic device, enabling complex commands to be transmitted to it.

The use of wired communication between the communication unit and the electronic device, can provide a stable connection that may be ideal for certain bandwidth- or latency-demanding applications.

Advantageously, the system for controlling the electronic device is adapted to operate via the branded mobile application of the user's vehicle.

This embodiment can improve the richness of communication between the electronic device and the vehicle. For example, brand-specific features could be integrated into the features, such as remote diagnostics or interface customization.

Another object of the invention is a method for controlling an electronic device from a vehicle by a control system, comprising the following steps: establishing a connection between the vehicle and the electronic device; in response to the establishment of the connection, transforming at least one command device of the vehicle into at least one means of commanding the electronic device; detecting a manual command via a first detection module or a voice instruction via a second detection module.

The method can establish a clear, structured workflow for integrating and controlling the electronic device. This method can provide a logical sequence of events, starting with establishing the connection, followed by transforming the commands, and finally detecting and interpreting the commands. This structured approach can guarantee consistent, reliable integration of the electronic device with the systems of the vehicle.

Advantageously, the method comprises a step, in response to the detection of a manual command, of transmitting to the electronic device a first command instruction associated with a direct control function of the electronic device.

This step can create a direct and immediate link between the user's physical actions on the command devices of the vehicle and the specific functions of the electronic device, resulting in rapid, intuitive control of the electronic device without the need for visual interaction, which is crucial for maintaining the driver's attention on the road.

Advantageously, the method comprises a step, in response to the detection of a voice instruction, of transmitting to the electronic device a second command instruction associated with a voice assistant function of the electronic device.

This step can enable the seamless integration of the voice recognition capabilities of the vehicle with the voice assistant of the electronic device, enabling hands-free interaction with the electronic device, greatly reducing visual and manual distractions for the driver.

### BRIEF DESCRIPTION OF THE DRAWINGS

Further advantages and features of the present invention are now described with the aid of examples which are illustrative only and by no means limit the scope of the invention, and from the appended drawings, in which the various figures represent:

FIG. 1 schematically represents the operating steps of a system for controlling the electronic device according to one embodiment.

FIG. 2 schematically represents a portion of the command devices of the vehicle according to one embodiment.

In the following description, identical elements, by structure or function, appearing on different figures retain the same references, unless otherwise specified.

### DETAILED DESCRIPTION

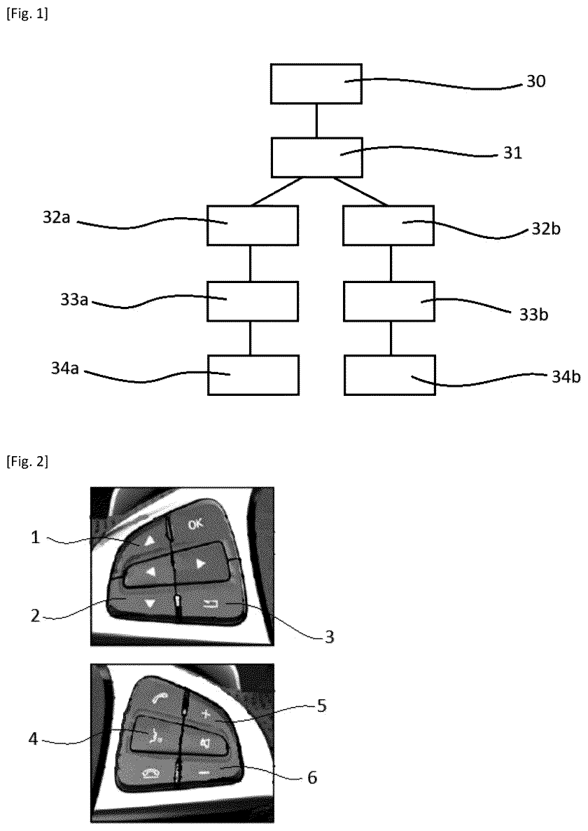

FIG. 1 shows the operating steps of a system for controlling an electronic device according to one embodiment. The system is also described in connection with FIG. 2 showing a portion of the command devices of the vehicle according to one embodiment.

The system is designed to control an electronic device from a vehicle.

In the case described, the electronic device is a smartphone. When the user gets into the vehicle, a connection (30) is established between the vehicle and the smartphone. To this end, the control system includes a connection detection module adapted to detect a connection (30) of the electronic device to the vehicle. In response to the establishment of the connection, the control system comprises a transition device (31) which, depending on the vehicle model, is activated either automatically by simply detecting the presence of the smartphone in the passenger compartment and therefore hassle-free for the user, or by pressing a specific manual control on the vehicle, or by selecting from a dedicated menu on the vehicle dashboard. The control features of the electronic device are immediately available as soon as the user enters the vehicle.

The transition device (31) is configured to transform a plurality of command devices of the vehicle into a plurality of means for commanding the smartphone. The vehicle command devices that are converted are manual vehicle command devices, i.e. center console buttons, steering wheel control buttons or the navigation wheel. The transition device is configured to transform the voice recognition device of the vehicle into a means for commanding the smartphone. The transition device operates on a source-switching system.

After the transformation (31), each of the vehicle's voice commands (32b) or manual commands (32a) is then interpreted as a control command on the electronic device.

Once the transformation (31) has been carried out, as soon as the user manually presses the command device, this is detected by a first detection module contained in said command device (32a). When the user interacts with one of the command devices, it is therefore the first detection module associated with it that detects said manual press command (32a) and transmits it to a control unit of the device (33a) itself capable of translating it into a simulated direct interaction with the smartphone.

Once the transformation has been completed, as soon as the user utters a voice command, it is detected by a second voice command detection module (32b) contained in the voice recognition device of the vehicle. The second command detection module is able to distinguish between standard voice commands and voice commands specific to a given application of the electronic device. When the user utters a command by voice, the second detection module associated with the voice recognition device of the vehicle detects said voice command (32b) and transmits it to the device's control unit (33b) to transform it into a smartphone command.

After the control unit has transformed the command detected by the first or second sensor module into a smartphone command, this smartphone command is transmitted to the communication unit. The communication unit which transmits it to the smartphone to apply said command in the form of a first (34a) or second type of function (34b). In the case of a voice command, the communication unit transmits the detected command to the voice assistant (34b) of the smartphone. The communication unit is adapted to communicate with the electronic device via a wireless or wired connection. The first type of function entails, among other things, scrolling through applications, opening a message, scrolling quickly through a list, accessing multimedia services without leaving the vehicle commands, selecting a contact for a call, managing music lists, and changing songs. The second type of function may entail, among other things, making a call or replying to a text message.

How to use the various command devices of the vehicle after they have been transformed by the transition device is described in more detail here.

The knob is used to navigate and select applications and other elements of the telephone interface. In addition to rotating to scroll through elements, the knob makes it possible to scroll freely and intuitively through the applications or menus of the smartphone. The touch knob is used for specific gestures on the electronic device, such as zooming or scrolling quickly through a list, as if the user were using a stylus. Buttons can be used to select particular application elements, activate specific functions, or interact with applications. In particular, control buttons on the steering wheel (1, 2, 3, 4, 5, 6) can provide quick access to the essential functions of the electronic device. In addition to the usual functions such as volume (5, 6) or call activation, the steering wheel buttons make it possible to navigate horizontally and vertically (1, 2) within the smartphone interface. This allows the driver to scroll through applications, lists or menu options directly from the steering wheel commands.

For example, the command devices (1, 2, 3, 4, 5, 6) shown in FIG. 2 have different functionalities when transformed into means for commanding the electronic device than what an ordinary user would be familiar with. For example, the arrows (1, 2) can be briefly pressed to scroll through applications or menus on the electronic device. A long press or double press on these buttons (1, 2) can be used to change the pages of the electronic device. A short press on the back button (3) can return the action, while a long press on the same button (3), once the connection (30) has been established, can enable the user to transform (31) the functionality of the buttons from commanding the electronic device to commanding the vehicle and vice versa, as desired, while keeping the connection (30) active.

The voice command button (4) can be briefly pressed to activate the voice assistance of the electronic device and thus control standard voice commands. A long press on the same button (4) can activate voice recording of the open application, and thus control application-specific voice commands.

The system is designed in such a way that when the transition device is activated, all command devices of the vehicle relating to safety functions retain their native function. In this way, the command devices that are critical to the safety and comfort of the user are totally independent of the mode in which the command devices of the vehicle are transformed into smartphone control means. Once the transformation has occurred, if a user attempts to use one of the command devices associated with vehicle safety, it will perform the function intended by the vehicle and not a command to the smartphone. Critical functions that retain their native function include air conditioning, heating, indicators, blinkers, hazard lights, and wipers, which remain autonomous and independent.

The foregoing description clearly explains how the invention achieves its objectives, i.e. to provide a system for complete control of the electronic device using the command devices of the vehicle, without requiring any modifications to the vehicle, using the build-in controls of the car and the voice recognition of the vehicle, by providing a system for controlling an electronic device from a vehicle, comprising at least one command device of the vehicle, at least one voice recognition device of the vehicle, a communication unit capable of establishing communication and exchanging data with the electronic device, and a transition device configured to transform the command device of the vehicle into a means for commanding the electronic device when the connection is established; to transmit to the electronic device by the communication unit a first command instruction, in response to a detection of a manual command by the first detection module, or to transmit to the electronic device by the communication unit a second command instruction, in response to a detection of a voice command by the second detection module, while keeping the vehicle safety controls active.

This objective is achieved through the implementation of this complete control which enables all the applications and features of the electronic device to be used directly by the controls and other features of the car, minimizing physical distractions, preventing hand-held use of the phone, and keeping the user from having to look away from the road. Furthermore, the indirect but complete control of the electronic device by the command devices of the vehicle can make it possible to comply with the law by limiting physical and visual distractions while keeping hands on the wheel, and therefore maintaining control of the vehicle while keeping the native safety functions of the vehicle accessible.

In any event, the invention is not limited to the embodiments specifically described in this document, and extends in particular to any equivalent means and to any technically operative combination of such means.

1. A system for controlling an electronic device from a vehicle, comprising:
at least one command device of the vehicle comprising a first manual command detection module;
at least one voice recognition device of the vehicle comprising a second voice command detection module;
a communication unit capable of establishing communication and exchanging data with the electronic device;
a transition device configured to:
after establishing a connection (30) between the electronic device and the vehicle, transform the at least one command device of the vehicle into at least one means for commanding the electronic device (31);
transmit to the electronic device, via the communication unit, a first command instruction for at least a first type of function of said electronic device (33a), in response to a detection of a manual command by the first detection module (32a);
transmit to the electronic device, via the communication unit, a second command instruction for at least a second type of function of said electronic device (33a), in response to a detection of a voice instruction by the second detection module (32b).

2. The control system according to claim 1, wherein the at least one command device comprises a button.

3. The control system according to claim 2, wherein the first command detection module is adapted to detect manual pressing of the button (32a).

4. The control system according to claim 1, wherein the second command detection module is adapted to detect a voice instruction (32b).

5. The control system according to claim 4, wherein the voice recognition device is adapted to transmit the detected voice instructions (33b) to a voice assistant of the electronic device.

6. The control system according to claim 1, wherein it comprises a connection detection module adapted to detect a connection (30) of the electronic device to the vehicle and to trigger the transformation (31) and transmission (32a, 32b) steps by activation of the transition device in response to the connection (30) detection.

7. The control system according to claim 6, wherein following activation of the transition device, the detection of a command (32a) by the first detection module causes the first command instruction to be sent to the electronic device (33a).

8. The control system according to claim 1, wherein the transformation (31) of the at least one command device of the vehicle into at least one means for commanding the electronic device control means is based on a source-switching system.

9. The control system according to claim 1, wherein the voice recognition device is adapted to distinguish standard voice commands from voice commands specific to a given application of the electronic device.

10. The control system according to claim 1, wherein the at least one command device associated with vehicle safety functions is adapted to retain its native functionality.

11. A method for controlling an electronic device from a vehicle by a control system according to claim 1, characterized in that it comprises the following steps:
establishing a connection (30) between the vehicle and the electronic device;
in response to establishing the connection (30), transforming at least one command device of the vehicle into at least one means for commanding the electronic device (31);
detecting a manual command via a first detection module (32a) or a voice instruction via a second detection module (32b).

12. The control method according to claim 11, wherein it comprises a step, in response to the detection of a manual command (32a), of transmitting to the electronic device a first command instruction associated with a direct control function of the electronic device (33a).

13. The control method according to claim 11, wherein it comprises a step, in response to the detection of a voice instruction (32a), of transmitting to the electronic device a second command instruction associated with a voice assistant function of the electronic device (33a).
